(19) United States
(12) Patent Application Publication
(10) Pub. No.: US 2018/0104710 A1
(43) Pub. Date: Apr. 19, 2018

(54) POWER SPRAYER AND METHOD

(71) Applicant: NELSON CABRAL, PORT MOODY (CA)

(72) Inventor: NELSON CABRAL, PORT MOODY (CA)

(21) Appl. No.: 15/464,321

(22) Filed: Mar. 20, 2017

Related U.S. Application Data
(60) Provisional application No. 62/409,873, filed on Oct. 18, 2016.

(51) Int. Cl. B05B 7/24; A01M 7/00

(52) U.S. Cl. CPC B05B 7/2491; A01M 7/0017; B05B 7/2475

(57) ABSTRACT

A power sprayer is disclosed herein. The power sprayer includes a support frame configured to mount to a back of a user, a liquid reservoir affixed to the support frame, and a fluid distribution wand hydraulically coupled to the liquid reservoir and configured to distribute the volume of liquid from the liquid reservoir. The power sprayer may further include a compressed air assembly affixed to the support frame. The compressed air assembly may include a compressed air tank and a pressure regulator. The compressed air assembly may be pneumatically coupled with the liquid reservoir and configured to internally pressurize a volume of liquid in the liquid reservoir with compressed air from the compressed air tank and via the pressure regulator and a plurality of valves. The power sprayer may be configured for autonomous mobility independent of an air compressor.

### CROSS-REFERENCE TO RELATED APPLICATION

The present application is related to and claims priority to U.S. Provisional Patent Application No. 62/409,873 filed Oct. 18, 2016, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### 1. Field of the Invention

The present invention relates generally to the field of liquid sprayers and more specifically relates to power garden sprayers.

### 2. Description of Related Art

Generally speaking garden sprayers are configured to be used in an industrial form, are quite large requiring the use of wheeled equipment for mobility and are typically powered by a gas engine. More commonly used garden sprayers are used around the home garden and landscape, this type sprayer is smaller and typically uses a mechanical hand pump to pressurize the fluid tank forcing the fluid out and through a spray wand for dispersion. Do to pressure variations within the fluid tank it is necessary to manually pump by hand to maintain adequate pressure for proper atomization while spraying. This is both time consuming and inefficient.

U.S. Pat. No. 5,931,207 to Rosario Gianino relates to a portable home and garden sprayer power unit. The described portable home and garden sprayer power unit includes a multi-purpose portable hand held compressed air power unit for spraying liquids from a tank or for inflating inflatable items. Said power unit having a trigger operated battery system and external electrical source provided in a housing having an electric motor and an air compressor. An air conduit pipe extends downwardly from the housing supplying compressed air into a liquid tank for spraying or to modified attachments attachable to inflate items such as tires, tubes, water floats or other inflatable items. The alternative electric power source can be used to replace the batteries.

### BRIEF SUMMARY OF THE INVENTION

In view of the foregoing disadvantages inherent in the known garden sprayer art, the present disclosure provides a novel power sprayer. The general purpose of the present disclosure, which will be described subsequently in greater detail, is to provide a power sprayer.

A power sprayer is disclosed herein. The power sprayer includes a support frame configured to mount to a back of a user, a liquid reservoir configured to hold a volume of liquid and affixed to the support frame, a fluid distribution wand hydraulically coupled to the liquid reservoir and configured to distribute the volume of liquid from the liquid reservoir and a compressed air assembly affixed to the support frame, the compressed air assembly including a compressed air tank and a pressure regulator, the compressed air assembly pneumatically coupled to the liquid reservoir and configured to internally pressurize the volume of liquid in the liquid reservoir with compressed air from the compressed air tank and via the pressure regulator. Certain embodiments may not comprise a frame. The alternate embodiments may comprise a uni-body design, or molded design (manufactured via injection molding or other). In these embodiments the piping or pressure reservoir and the like may be integrated within the manufacture.

According to another embodiment, a method for spraying a liquid is also disclosed herein. The method includes the steps of: closing a plurality of valves, connecting a pressurized air feed line to an air compressor, filling a liquid reservoir with a liquid opening a system charge valve and charging a compressed air tank, closing the system charge valve and resealing a fill port, disconnecting a pressurized air feed line then opening a liquid reservoir charge valve, adjusting an air pressure regulator to a desired pressure; and dispersing volume of liquid using fluid distribution wand.

For purposes of summarizing the disclosure, certain aspects, advantages, and novel features of the disclosure have been described herein. It is to be understood that not necessarily all such advantages may be achieved in accordance with any one particular embodiment of the disclosure. Thus, the disclosure may be embodied or carried out in a manner that achieves or optimizes one advantage or group of advantages as taught herein without necessarily achieving other advantages as may be taught or suggested herein. The features of the disclosure which are believed to be novel are particularly pointed out and distinctly claimed in the concluding portion of the specification. These and other features, aspects, and advantages of the present disclosure will become better understood with reference to the following drawings and detailed description.

### BRIEF DESCRIPTION OF THE DRAWINGS

The figures that accompany the written portion of this specification illustrate embodiments and methods of use for the present disclosure, a power sprayer and method, constructed and operative according to the teachings of the present disclosure.

FIG. 1 is a perspective view of the power sprayer during an ‘in-use’ condition, according to an embodiment of the disclosure.

FIG. 2 is a top perspective view of the power sprayer of FIG. 1, according to an embodiment of the present disclosure.

FIG. 3 is a side view of a liquid reservoir of the power sprayer of FIG. 1, according to an embodiment of the present disclosure.

FIG. 4 is a schematic view of a compressed air assembly of FIG. 1, according to an embodiment of the present disclosure.

FIG. 5 is a flow diagram illustrating a method of use for the power sprayer, according to an embodiment of the present disclosure.

The various embodiments of the present disclosure will hereinafter be described in conjunction with the appended drawings, wherein like designations denote like elements.

### DETAILED DESCRIPTION

As discussed above, embodiments of the present disclosure relate to a liquid sprayer and more particularly to a power garden sprayer as used to improve the power sprayer. Generally, the power sprayer is designed for professional service people spraying liquids in the commercial landscape maintenance industry, garden nurseries and agricultural farms. The power sprayer is unique in the following way: instead of having to be constantly hand pumping, before or during your spraying operation, the power sprayer never requires pumping.

Handheld or backpack commercial sprayers never achieve a constant optimal spraying pressure. After you have stopped pumping and begin spraying, your spraying pressure immediately begins to degrade. With the power sprayer, you are able to adjust spraying pressure until you find what is optimal for the conditions you are working with and with what you are most satisfied. Once you find that “sweet spot” for your sprayer and nozzle, the spray pressure remains the same from the beginning until the end when you empty the contents in the sprayer tank.

There are two principle units that make up the power sprayer: the compressor unit, and the sprayer unit, which includes a sprayer tank with hose and wand, along with a small compressed air tank.

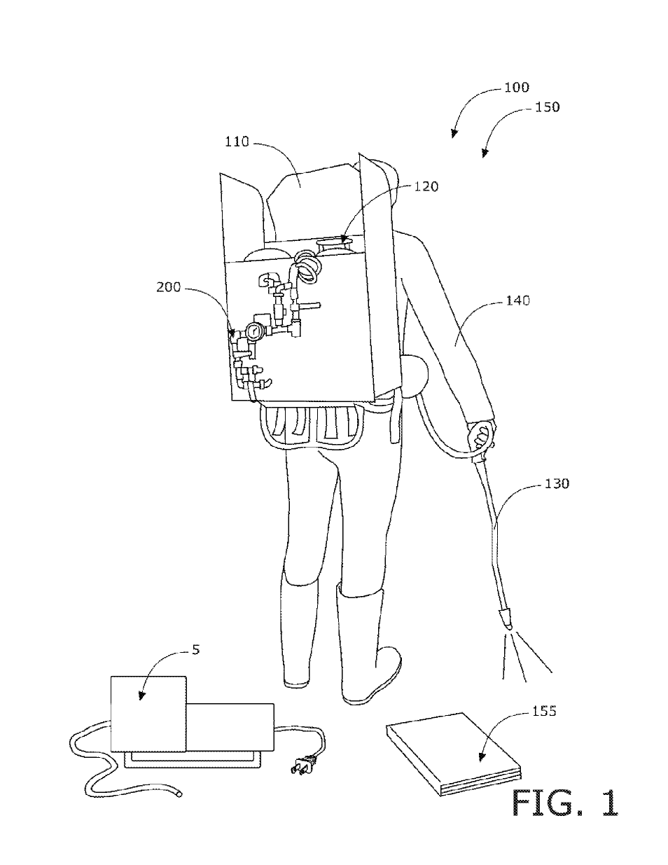

Referring now more specifically to the drawings by numerals of reference, there is shown in FIGS. 1-4, various views of a power sprayer 100. According to one embodiment, the power sprayer may dispense two U.S. gallons of liquid using a one U.S. gallon aluminum compressed air tank. Here, the spraying unit may include the sprayer tank with hose and spray wand, as above, along with a one gallon aluminum compressed air tank with control valves, hoses and air pressure regulator.

FIG. 1 shows a power sprayer 100 during an ‘in-use’ condition 150, according to an embodiment of the present disclosure. Here, the power sprayer 100 may be beneficial for use by a user 140 to disperse liquid. As illustrated, the power sprayer 100 may include a support frame 110 configured to mount to a back of a user 140, a liquid reservoir 120, configured to hold a volume of liquid and affixed to the support frame 110, a fluid distribution wand 130, hydraulically coupled to the liquid reservoir 120, and configured to distribute the volume of liquid from the liquid reservoir 120, and a compressed air assembly 200 affixed to the support frame 110.

The support frame 110, may be substantially made of lightweight composite materials or durable alloy materials. The support frame 110, may include carrying straps configured to mount the support frame to the back of the user 140. the power sprayer 100 is configured for autonomous mobility independent of a compressed air source.

According to one embodiment, the compressed air assembly 200 may include and/or be configured to receive compressed air from a compressed air source 5. For example, the compressed air source 5 may include or otherwise be powered by a compressor unit that runs on 110 volts AC. The power draw rating for the unit may be 4 amps at 115 volts. The unit may have a one half horsepower electric motor, and/or can be easily ran off of an automobile AC inverter. This may be primarily how the unit would be used by personnel in the commercial landscape maintenance field.

According to one embodiment, the power sprayer 100 may be arranged as a kit 105. In particular, the power sprayer 100 may further include a set of instructions 155. The instructions 155 may detail functional relationships in relation to the structure of the power sprayer 100 (such that the power sprayer 100 can be used, maintained, or the like, in a preferred manner).

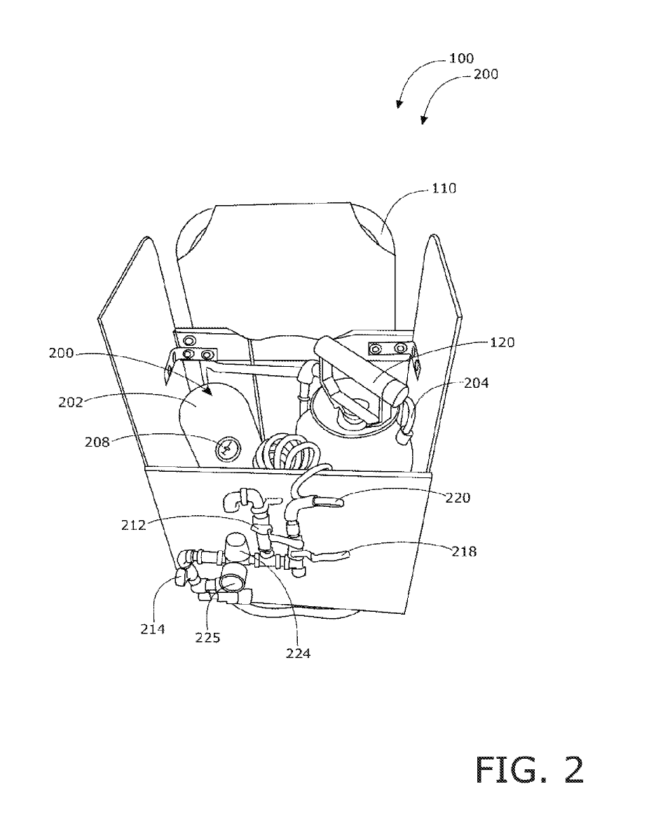

FIG. 2 is a top perspective view of the power sprayer of FIG. 1, according to an embodiment of the present disclosure. As above the power sprayer 100 may include the support frame 110, the liquid reservoir 120, the fluid distribution wand 130, and the compressed air assembly 200 in structural and functional combination.

The compressed air assembly 200 may include a compressed air tank 202 and an air pressure regulator 224. The compressed air assembly 200 may be pneumatically coupled to the liquid reservoir 120, and may be configured to internally pressurize the volume of liquid in the liquid reservoir 120, with compressed air from the compressed air tank 202, via the pressure regulator 224. Thus, the air pressure regulator 224 may be configured to regulate internal pressurization of the liquid reservoir 120. According to one embodiment, the air pressure regulator 224 may include a pressure gauge 225 that is readable from outside of the support frame 110.

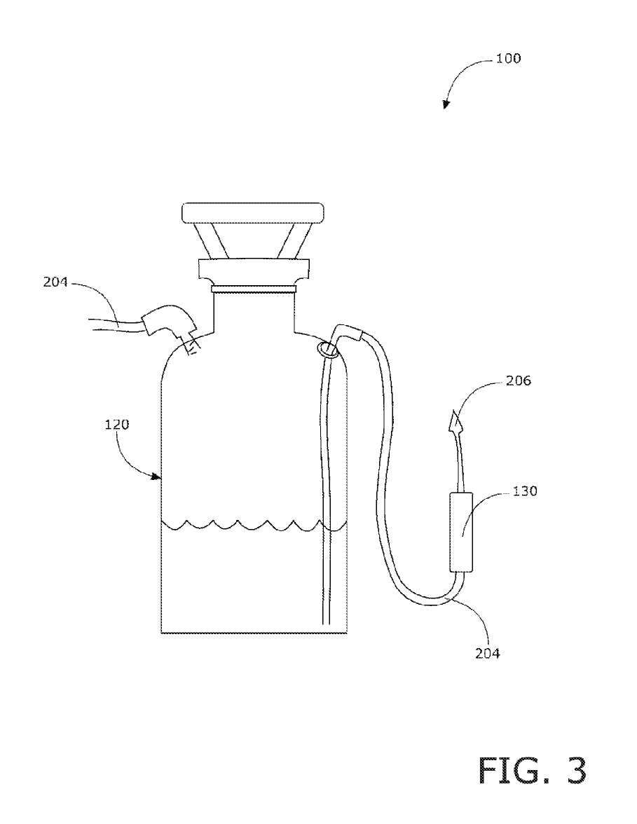

FIG. 3 is a side view of a liquid reservoir of the power sprayer of FIG. 1, according to an embodiment of the present disclosure. The fluid distribution wand 130 is hydraulically coupled to the liquid reservoir 120 via at least one tube 204 or other plumbing. The fluid distribution wand 130 may include and be configured to control atomization dispersion via a spray nozzle 206.

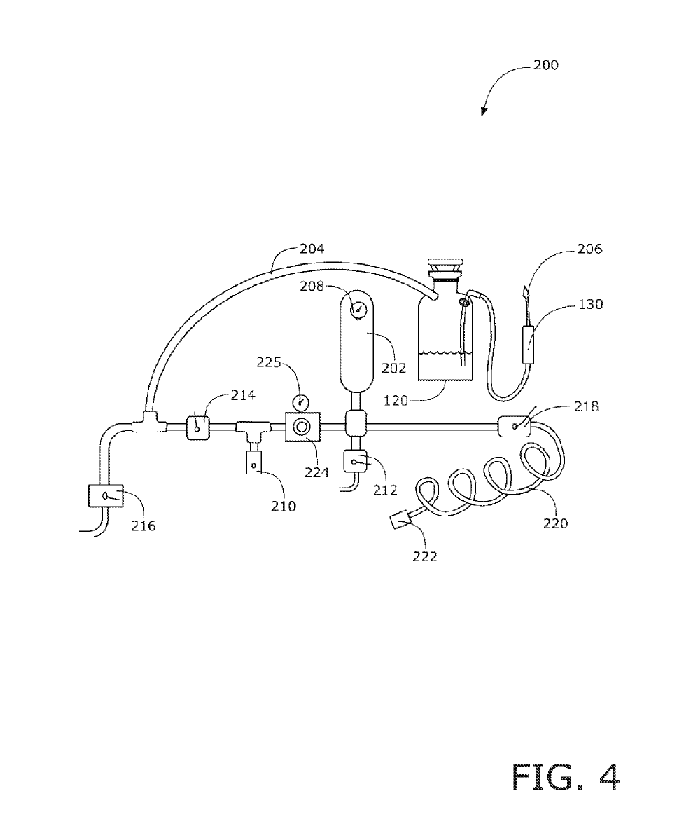

FIG. 4 is a schematic view of a compressed air assembly of FIG. 1, according to an embodiment of the present disclosure. The compressed air assembly 200 may further include an air pressure gauge 208 pneumatically coupled to the compressed air tank 202. The compressed air tank 202, may be pneumatically coupled to the liquid reservoir 120, via at least one tube 204 or other plumbing.

The compressed air assembly 200 may further include a plurality of valves pneumatically coupled to the compressed air tank 202. The plurality of valves may include a high pressure relief valve 210 configured to release stored air pressure at a predefined pressure, a storage pressure release valve 212 configured to release stored air pressure upon a user command. The plurality of valves may also include a liquid reservoir charge valve 214 configured to provide internal pressurization of the liquid reservoir 120, a liquid reservoir relief valve 216 configured to release residual liquid reservoir air pressure upon a user command.

The compressed air assembly 200 may further include a pneumatically coupled system charge valve 218 and a pressurized air feed line 220 configured to receive compressed air from the compressed air source 5 (FIG. 1) external to the compressed air assembly 200. The pressurized air feed line 220 may be configured to releasably be pneumatically coupled to the system charge valve 218 and/or the compressed air source 5, external to the compressed air assembly 200. The pressurized air feed line 220 may further include a quick-release coupling 222.

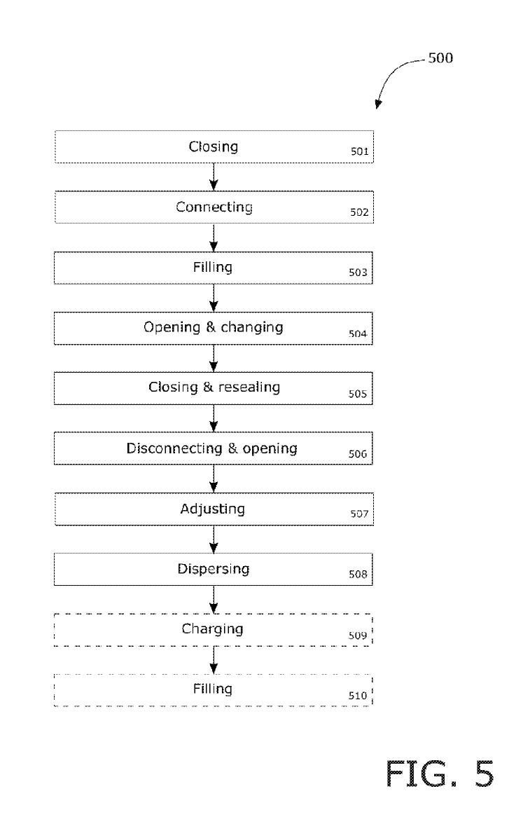

FIG. 5 is a flow diagram illustrating a method for power sprayer, according to an embodiment of the present disclosure. In particular, the method for power sprayer or method of use (method of spraying a liquid 500) may include one or more components or features of the power sprayer 100 as described above, and as provided to a user. As illustrated, the method for method of use 500 may include the steps of: closing 501 a plurality of valves, connecting 502 a pressurized air feed line to a compressed air source, filling 503 a liquid reservoir with a liquid, opening 504 a system charge valve and charging a compressed air tank, closing 505 the system charge valve and resealing a fill port, and disconnecting 506 the pressurized air feed line and then opening a liquid reservoir charge valve, adjusting 507 the air pressure regulator to a desired pressure, dispersing 508 a volume of liquid using the fluid distribution wand.

According to one embodiment, the method of spraying a liquid 500 may further include charging 509 the compressed air tank, and concurrently, filling 510 the liquid reservoir with the liquid and filling. It should be noted that these are optional steps and may not be implemented in all cases.

To illustrate one embodiment, the spraying unit may be carried by maintenance personnel, either via shoulder strap or via backpack. Once the compressor unit is turned on. It works automatically and will turn off when the compressed air tank pressure reaches 125 psi. When the operator connects the air hose with female quick connector from the compressor unit to the male connector and short length of air hose with male connector on the sprayer unit—and the valves on the sprayer unit is set, the compressor unit automatically turns on and continues for about two minutes for the initial fill of the compressed air tank. When the air pressure on the sprayer unit air tank reaches 125 psi the compressor unit automatically turns off.

When the valves are set and the male and female quick connect couplers are disconnected, the two units may be separated. When the valve(s) are set the spraying unit can now be operated and its fluid contents dispensed at the operators desired optimal pressure. The sprayer unit is configured to allow for refilling of the sprayer tank with liquid contents while the compressor unit can be filling the air pressure tank on the spraying unit. During subsequent fillings of the compressed air tank, because there is still residual air pressure in the compressed air tank filling takes less than two minutes. Before the operator has refilled the sprayer tank with new liquid contents, the charging of the sprayer unit compressed air tank has been completed.

With the compressed air tank filled to a pressure of 125 psi, this enables the dispensing of the entire contents of the two U.S. gallon sprayer tank at a constant pressure of 30 psi. The unit can dispense at any pressure below 30 psi its entire contents of the two U.S. gallon spray tank. If higher dispensing pressures are required, it is a matter of increasing the pressure to the compressed air tank and/or supplying a larger tank. If the operator filled the sprayer unit with liquid content and charged the sprayer tank unit with air and then realized he had forgotten an ingredient for the liquid content, say he needs to add some soap, the control valves allow a user to isolate the sprayer tank and vent the compressed air while isolating the air from the compressed air tank. The advantage to this is the operator is not required to dump the pressurized air out of his compressed air tank in order to take care of his oversight.

It should be noted that optional steps of method of use 500 are illustrated using dotted lines in FIG. 5 so as to distinguish them from the other steps of method of use 500. It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for power sprayer (e.g., different step orders within above-mentioned list, elimination or addition of certain steps, including or excluding certain maintenance steps, etc.), are taught herein.

The embodiments of the disclosure described herein are exemplary and numerous modifications, variations and rearrangements can be readily envisioned to achieve substantially equivalent results, all of which are intended to be embraced within the spirit and scope of the disclosure. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A power sprayer comprising:
a support frame configured to mount to a back of a user;
a liquid reservoir configured to hold a volume of liquid and affixed to the support frame;
a fluid distribution wand hydraulically coupled to the liquid reservoir and configured to distribute the volume of liquid from the liquid reservoir; and
a compressed air assembly affixed to the support frame, the compressed air assembly including a compressed air tank and a pressure regulator, the compressed air assembly pneumatically coupled to the liquid reservoir and configured to internally pressurize the volume of liquid in the liquid reservoir with compressed air from the compressed air tank and via the pressure regulator.

2. The power sprayer of claim 1, wherein the support frame is substantially made of lightweight composite materials.

3. The power sprayer of claim 1, wherein the support frame is substantially made of durable alloy materials.

4. The power sprayer of claim 1, wherein the fluid distribution wand is hydraulically coupled to the liquid reservoir via at least one tube.

5. The power sprayer of claim 1, wherein the fluid distribution wand includes a spray nozzle configured to control atomization dispersion.

6. The power sprayer of claim 1, wherein the compressed air assembly further includes an air pressure gauge pneumatically coupled to the compressed air tank.

7. The power sprayer of claim 1, wherein the compressed air tank is pneumatically coupled to the liquid reservoir via at least one tube.

8. The power sprayer of claim 1, wherein the compressed air assembly further includes a plurality of valves pneumatically coupled to the compressed air tank, the plurality of valves including a high pressure relief valve configured to release stored air pressure at a predefined pressure.

9. The power sprayer of claim 8, wherein the plurality of valves further includes a storage pressure release valve configured to release stored air pressure upon a user command.

10. The power sprayer of claim 8, wherein the plurality of valves further includes a liquid reservoir charge valve configured to provide internal pressurization of the liquid reservoir.

11. The power sprayer of claim 8, wherein the plurality of valves further includes a liquid reservoir relief valve configured to release residual liquid reservoir air pressure upon a user command.

12. The power sprayer of claim 8, wherein the compressed air assembly further comprises a pneumatically coupled system charge valve configured to receive compressed air from a compressed air source external to the compressed air assembly.

13. The power sprayer of claim 12, further comprising a pressurized air feed line configured to releasably pneumatically couple to the system charge valve and the compressed air source external to the compressed air assembly.

14. The power sprayer of claim 13, wherein the pressurized air feed line includes a quick-release coupling.

15. The power sprayer of claim 1, wherein the pressure regulator is configured to regulate liquid reservoir internal pressurization.

16. The power sprayer of claim 1, wherein the support frame further includes carrying straps configured to mount the support frame to the back of the user.

17. The power sprayer of claim 1, wherein the power sprayer is configured for autonomous mobility independent of an air compressor.

18. A power sprayer comprising:
a support frame configured to mount to a back of a user;
a liquid reservoir configured to hold a volume of liquid and affixed to the support frame;
a fluid distribution wand hydraulically coupled to the liquid reservoir and configured to distribute the volume of liquid from the liquid reservoir; and
a compressed air assembly affixed to the support frame, the compressed air assembly including a compressed air tank and a pressure regulator, the compressed air assembly pneumatically coupled to the liquid reservoir and configured to internally pressurize the volume of liquid in the liquid reservoir with compressed air from the compressed air tank and via the pressure regulator; and
a pressurized air feed line configured to releasably pneumatically couple to the system charge valve and the compressed air source external to the compressed air assembly; and
wherein the support frame is substantially made of durable alloy materials;
wherein the fluid distribution wand is hydraulically coupled to the liquid reservoir via at least one tube;
wherein the fluid distribution wand includes a spray nozzle configured to control atomization dispersion;
wherein the compressed air assembly further includes an air pressure gauge pneumatically coupled to the compressed air tank;
wherein the compressed air tank is pneumatically coupled to the liquid reservoir via at least one tube;
wherein the compressed air assembly further includes a plurality of valves pneumatically coupled to the compressed air tank, the plurality of valves including a high pressure relief valve configured to release stored air pressure at a predefined pressure;
wherein the plurality of valves further includes a storage pressure release valve configured to release stored air pressure upon a user command;
wherein the plurality of valves further includes a liquid reservoir charge valve configured to provide internal pressurization of the liquid reservoir;
wherein the plurality of valves further includes a liquid reservoir relief valve configured to release residual liquid reservoir air pressure upon a user command;
wherein the compressed air assembly further comprises a pneumatically coupled system charge valve configured to receive compressed air from a compressed air source external to the compressed air assembly;
wherein the pressurized air feed line includes a quick-release coupling;
wherein the pressure regulator is configured to regulate liquid reservoir internal pressurization;
wherein the support frame further includes carrying straps configured to mount the support frame to the back of the user; and
wherein the power sprayer is configured for autonomous mobility independent of an air compressor.

19. A method for spraying a liquid, the method comprising the steps of:
providing a power sprayer affixed to a support frame to be mounted to a back of a user;
closing a plurality of valves;
connecting a pressurized air feed line to an air compressor;
filling a liquid reservoir with a liquid;
opening a system charge valve and charging a compressed air tank;
closing the system charge valve and resealing a fill port;
disconnecting a pressurized air feed line and then opening a liquid reservoir charge valve;
adjusting an air pressure regulator to a desired pressure; and
dispersing volume of liquid using a fluid distribution wand.

20. The method of claim 19, further comprising the steps of:
charging the compressed air tank; and
filling the liquid reservoir with the liquid concurrently with the charging the compressed air tank.
